(19) United States
(12) Patent Application Publication
(10) Pub. No.: US 2008/0007491 A1
(43) Pub. Date: Jan. 10, 2008

(54) Mirror having a field emission information display

(76) Inventor: Kuei Wen Cheng, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/480,404

(22) Filed: Jul. 5, 2006

(51) Int. Cl. G09G 3/22

(52) U.S. Cl. 345/75.2

(57) ABSTRACT

A mirror having a field emission information display includes a semitransmitting reflecting mirror body for a rear vision mirror installed in the car, a field emission unit, a control unit, and a satellite navigation module. The field emission unit is installed in the semitransmitting reflecting mirror body. The control unit is installed in the semitransmitting reflecting mirror body and is connected with the field emission unit for controlling the field emission unit to display information images. The satellite navigation module is installed in the semitransmitting reflecting mirror body and is connected with the control unit for receiving a satellite signal and transmitting the satellite signal to the control unit. Thereby, the satellite signal is controlled by the control unit so as to be transmitted to the field emission unit. The field emission unit generates an information image area on the surface of the semitransmitting reflecting mirror body.

### BACKGROUND OF THE INVENTION

1. Field of the Invention

The present invention relates to a mirror having a field emission information display. In particular, this invention relates to a mirror having a field emission information display that combines a field emission unit and a semitransmitting reflecting mirror. The mirror having a field emission information display generates general information to display the car's speed, and utilizes a color light to display the map path, and notifications regarding actions that need to be taken (such as making a turn).

2. Description of the Related Art

As technology has been rapidly developed, the car industry has combined with space technology, such as satellite navigation systems. Satellite navigation systems utilize positioning information provided from the satellite positioning system and satellites to provide the car's exact location. The positioning location is compared to the built-in map in the navigation system so as to let the driver know the current location and provide an optimal driving route to the driver. In order to let the driver watch the complex driving information provided while the driver is driving, the satellite navigation system usually adopts a flat display. The most desirable features of such a system are that it uses little power occupies as little space as possible.

The flat display is placed in front of the driving seat so that the driver can view the displayed information clearly. In order to receive the satellite signals, the antenna connected between the satellite system and the navigation system is placed on the windscreen.

The display used in the car navigation system has changed from cathode-ray tubes (CRT) to liquid crystal display (LCD). Currently, field emission displays are being developed. Field emission display (FED) makes the CRT become flatter and thinner. The displaying principle of FED is similar to that of the CRT. Both emit electrons from the cathode. The electrons pass through a vacuum and are accelerated by the anode to excite fluorescence to light. The fluorescence used for CRT is the same as that of FET. The main difference is the generating method of the electrons. General CRT generates electrons via heating the cathode. The FET absorbs the electrons from the cathode via an electric field. Therefore, the FED is more suitable to be a display used for the car displaying device.

Reference is made to FIG. 1, which shows a schematic diagram of an FED 1a of the prior art. The FED 1a includes an anode 3a and a cathode 4a. A unit structure 5a includes a unit anode 51a and a unit cathode 52a. A rib 53a is located between the unit anode 51a and the unit cathode 52a to form a vacuum area between the anode 3a and the cathode 4a and support the anode 3a and the cathode 4a. The anode 3a includes an anode substrate 31a, an anode conducting layer 32a, and a fluorescence powder layer 33a. The cathode 4a includes a cathode substrate 41a, a cathode conducting layer 42a, and an electron emission layer 43a. The rib 53a is located between the anode 3a and the cathode 4a to form a vacuum area. Then, an external electrical field is provided to make the electron emission layer 43a of the cathode 4a generate electrons. The electrons are emitted to the fluorescence powder layer 33a of the anode 3a so that the fluorescence powder layer 33a is excited to light.

### SUMMARY OF THE INVENTION

One particular aspect of the present invention is to provide a mirror having a field emission information display. The present invention combines the two polar structure of a field emission unit with a semitransmitting reflecting mirror so that the brightness of information generated on the semitransmitting reflecting mirror is greater than 300 cd/m². The size of the generated pixel unit is below 200 μm. Therefore, the information image is detailed and colorful. The mirror having a field emission information display is combined with a satellite navigation module. It provides general information to show the car's speed and can be used as a night lamp. Furthermore, it also uses a color light to show map routes or inform the driver that they need to make a turn. When the mirror is not used to show the information image, it can be used as a mirror. The driver can observe incoming cars via the mirror. In order to receive satellite positioning signals clearly, the satellite navigation module is located on one side of the reflecting mirror.

The mirror having a field emission information display of the present invention includes a semitransmitting reflecting mirror body for a rear vision mirror installed in the car, a field emission unit, a control unit, and a satellite navigation module. The field emission unit is installed in the semitransmitting reflecting mirror body. The field emission unit includes an anode structure, a cathode structure corresponding to the anode structure, and an insulating structure located between the anode structure and the cathode structure to form a specified gap. The anode structure has an anode conducting layer, and an anode layer located above the anode conducting layer. The cathode structure has a cathode conducting layer, and a cathode layer located above the cathode conducting layer. The control unit is installed in the semitransmitting reflecting mirror body and is connected with the field emission unit for controlling the field emission unit to display the information. The satellite navigation module is installed in the semitransmitting reflecting mirror body and is connected with the control unit for receiving a satellite signal and transmitting the satellite signal to the control unit. Thereby, the satellite signal is controlled by the control unit so as to be transmitted to the field emission unit. The field emission unit generates an information image area on the surface of the semitransmitting reflecting mirror body.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the mirror having a field emission information display of the prior art;

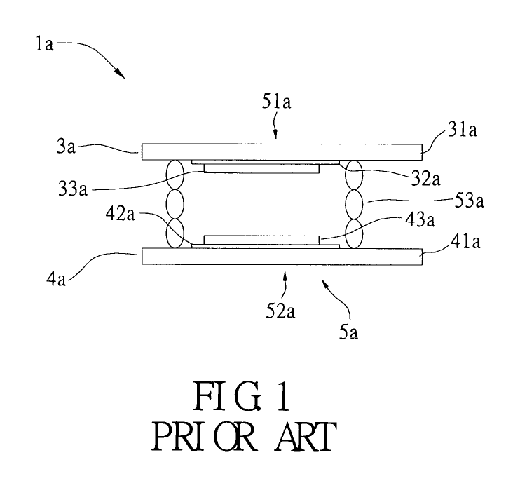

FIG. 2 is a cross-sectional view of the mirror having a field emission information display of the present invention;

FIG. 3 is a block diagram of the mirror having a field emission information display of the present invention;

FIG. 4 is a block diagram of the driving circuit module of the mirror having a field emission information display of the present invention;

FIG. 5 is a block diagram of the power circuit module of the mirror having a field emission information display of the present invention;

FIG. 6 is a block diagram of the feedback circuit module of the mirror having a field emission information display of the present invention; and

FIG. 7 is a perspective view of the display function of the mirror having a field emission information display of the present invention.

### DETAILED DESCRIPTION OF THE PREFERRED EMBODIMENTS

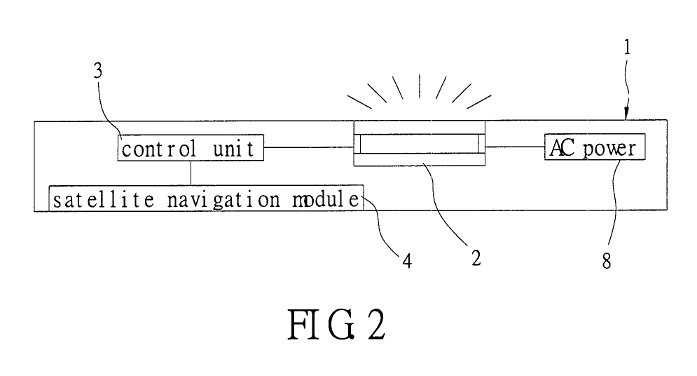

Reference is made to FIG. 2, which shows a cross-sectional view of the mirror having a field emission information display of the present invention. The mirror having a field emission information display of the present invention includes a semitransmitting reflecting mirror body 1 for a rear vision mirror installed in the car, a field emission unit 2 installed in the semitransmitting reflecting mirror body 1, a control unit 3 installed in the semitransmitting reflecting mirror body 1 and electrically connected with the field emission unit 2, a satellite navigation module 4 installed in the semitransmitting reflecting mirror body 1 and electrically connected with the control unit 3, and an AC power 8. The control unit 3 controls the field emission unit 2 to generate an image information. The satellite navigation module 4 transmits a satellite signal to the control unit 3 and displays an information image on the surface of the semitransmitting reflecting mirror body 1 via the field emission unit 2. The AC power 8 is electrically connected with the field emission unit 2 to dynamically display the information image.

The field emission unit 2 includes an anode structure, a cathode structure corresponding to the anode structure, and an insulating structure located between the anode structure and the cathode structure to form a specified gap. The insulating structure can be 40˜100 μm. The preferred embodiment is 50˜70 μm. The anode structure has an anode conducting layer, and an anode layer located above the anode conducting layer. The cathode structure has a cathode conducting layer, and a cathode layer located above the cathode conducting layer. The anode layer is a fluorescence layer. The cathode is an emission layer. Alternatively, the cathode is a carbon nanotube layer formed by coating or screen printing by electrophoresis. The emission layer can be a carbon nanotube layer or a tiny metal pointed layer. The anode layer is made of fluorescence powder that is patterned and can display three original colors, including red, green, and blue. The thickness of the fluorescence powder layer is within a specified range. The thickness of the anode layer is 2˜10 μm. The preferred embodiment is 4˜8 μm. The thickness of the cathode layer is 1˜20 μm. The preferred embodiment is 5˜10 μm. The thickness of the insulating layer is within a specified range.

Furthermore, the anode structure further combines with a reflecting layer. The reflecting layer is located on a side of the anode structure that is opposite to the anode conducting layer. The reflecting layer combines a metal material (such as aluminum) on the anode structure by an evaporation method. Alternatively, the reflecting layer is combined to the anode structure by a pasting-film method. The reflecting layer enhances the brightness of the displaying information.

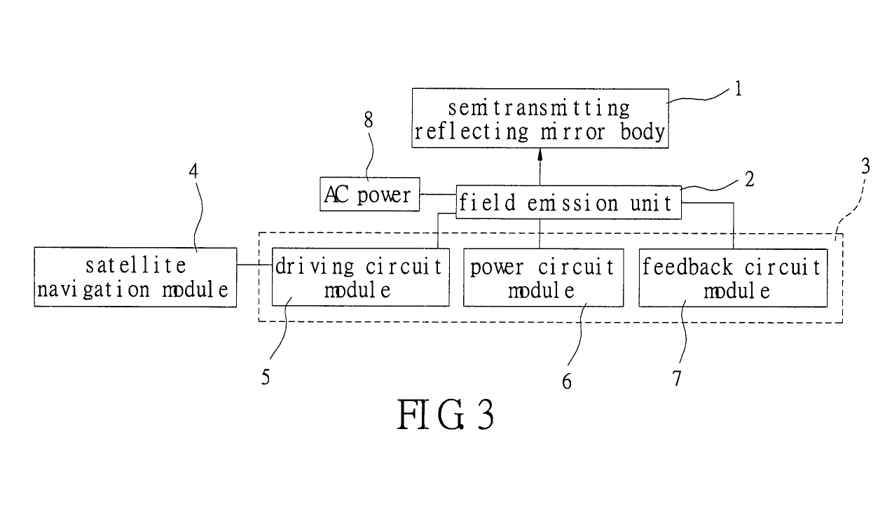

Reference is made to FIG. 3, which shows a block diagram of the mirror having a field emission information display of the present invention. The mirror having a field emission information display includes a semitransmitting reflecting mirror body 1 for a rear vision mirror installed in the car, a field emission unit 2, a control unit 3, and a satellite navigation module 4. The control unit 3 is electrically connected with the field emission unit 2 to control the information display of the field emission unit 2. The control unit 3 includes a driving circuit module 5, a power circuit module 6, and a feedback circuit module 7. The driving circuit module 5 controls the field emission unit 2 to display an information image. The power circuit module 6 controls and increases the current density of the field emission unit 2. The power circuit module 6 increases the lighting efficiency, and prevents the field emission unit 2 from over-heating so that the life of the field emission unit 2 is lengthened. The feedback circuit module 7 balances the brightness of the field emission unit 2.

An AC power 8 is electrically connected with the field emission unit 2. The AC power 8 cooperates with the driving circuit module 5 to make the field emission unit 2 dynamically display the information image.

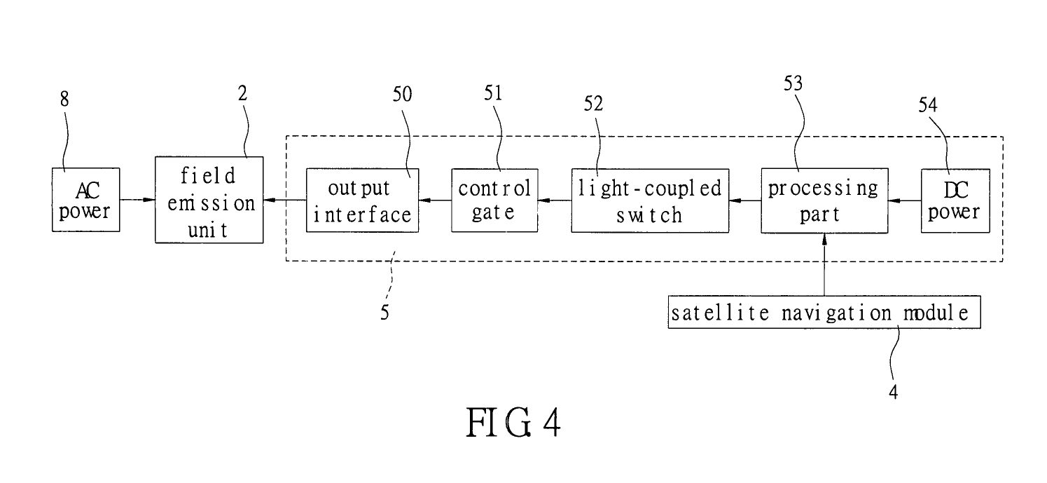

Reference is made to FIG. 4, which shows a block diagram of the driving circuit module of the mirror having a field emission information display of the present invention. The driving circuit module 5 includes an output interface 50 connected with the cathode structure of the field emission unit 2, at least one control gate 51 connected with the output interface 50, at least one light-coupled switch 52 connected with the control gate 51, a processing part 53 connected with the light-coupled switch 52. The processing part 53 is connected with a DC power 54, and provides the power required by the processing part 53. A control signal drives the light-coupled switch 52, and controls the control gate 51 connected with the light-coupled switch 52 to work. The light-coupled switch 52 separates and protects the processing part 53.

The satellite navigation module 4 is electrically connected with the processing part 53 of the driving circuit module 5. The satellite navigation module 4 receives a satellite signal, and transmits the satellite signal to the processing part 53. The processed satellite signal is outputted to the field emission unit 2 via the output interface 50. The satellite signal generates an information image on the surface of the semitransmitting reflecting mirror body 1 via the field emission unit 2.

An AC power 8 is connected with the anode structure of the field emission unit 2. When the cathode structure of the field emission unit 2 is grounded, the cathode layer of the cathode structure generates electrons, and the electrons are accelerated by the AC power 8 located between the anode structure and the cathode structure to excite the anode layer located above anode structure to light. The insulating structure located above the cathode structure separates the electrons generated between the cathode layers to prevent the electrons from disturbing each other.

When the control gate 51 controls the cathode structure to be floated, no driving electric field is built between the anode structure and the cathode structure. The electrons cannot be generated from the cathode structure. Therefore, the field emission unit 2 cannot display any information images.

Because the anode structure of the field emission unit 2 is connected with the AC power 8, the field emission unit 2 will light and display the information image when the AC power is a positive electric field and the cathode structure of the field emission unit 2 is grounded. Alternatively, when the cathode structure of the field emission unit 2 is floated, the field emission unit 2 cannot display any information image. Therefore, by connecting the anode structure with a high frequency AC power 8 and controlling the cathode to be grounded or floated, the field emission unit 2 can dynamically display the information image.

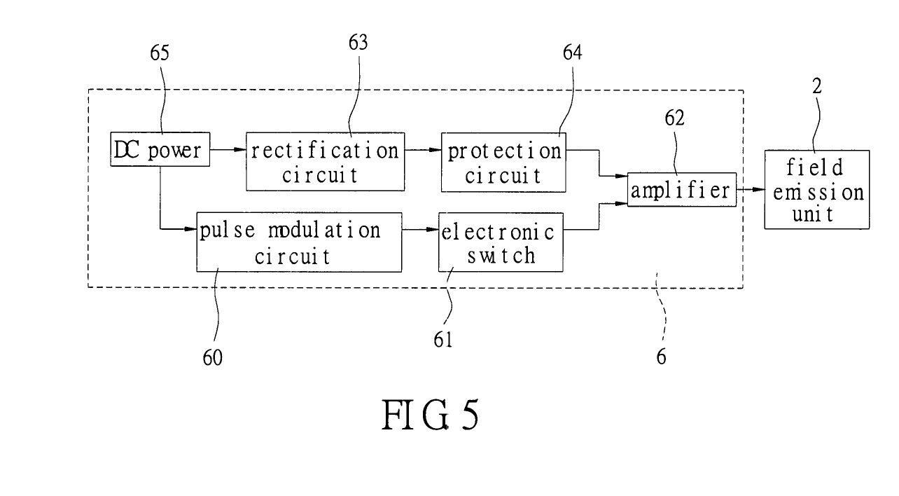

Reference is made to FIG. 5, which shows a block diagram of the power circuit module of the mirror having a field emission information display of the present invention. The power circuit module 6 includes a pulse modulation circuit 60 connected with a DC power 65, an electronic switch 61 connected with the pulse modulation circuit 60, an amplifier 62 connected with the DC power 65 and the electronic switch 61, a rectification circuit 63 connected with the DC power 65 and the amplifier 62, and a protection circuit 64 connected with the DC power 65 and the amplifier 62. The DC power 65 is connected with the rectification circuit 63 and the pulse modulation circuit 60 for providing the power required for the field emission unit 2. The rectification circuit 63 boosts the voltage of the DC power 65, and is connected with the protection circuit 64. The protection circuit 64 is used for preventing the circuit from being over-voltage and over-current. The pulse modulation circuit 60 is connected with the electronic switch 61, and generates a modulation signal according to the DC power 65 so as to control the electronic switch 61 for switching the power.

The amplifier 62 is connected with the protection circuit 64 and the electronic switch 61. The amplifier 62 amplifies the boosted DC power 65 to generate a high frequency and intermittence power according to the high frequency power switching operation of the electronic switch 62, and the high frequency and intermittence power is provided to the field emission unit 2.

One end of the amplifier 62 is connected with the anode structure of the field emission unit 2, and another end of the amplifier 62 is connected with the cathode structure of the field emission unit 2 to provide the AC power required for the field emission unit 2. Therefore, via a high voltage and a high frequency AC power, the lighting efficiency of the field emission unit 2 increases, and prevents the field emission unit 2 from over-heating to lengthen the life of the field emission unit 2.

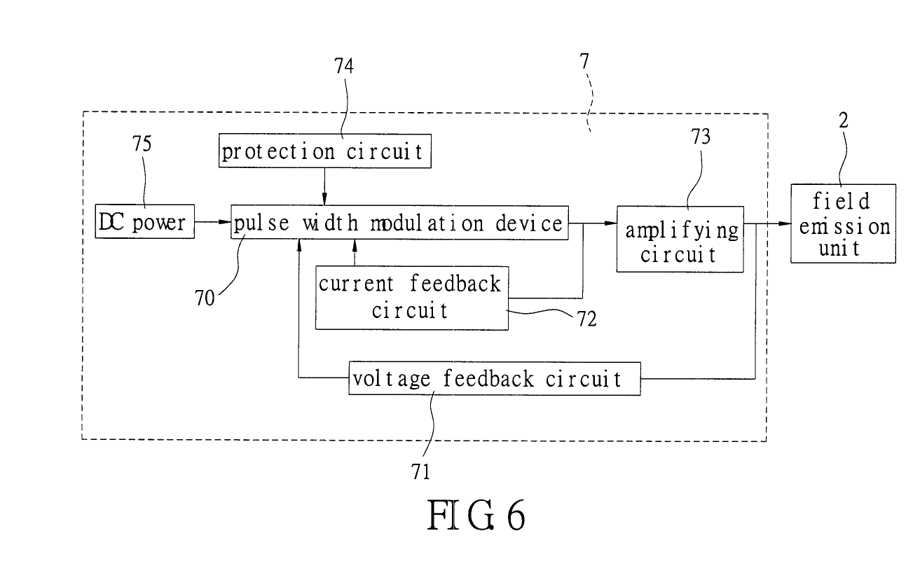

Reference is made to FIG. 6, which shows a block diagram of the feedback circuit module of the mirror having a field emission information display of the present invention. The feedback circuit module 7 includes a pulse width modulation device 70 connected with a DC power 75 and converting the DC power 75 into AC power, a voltage feedback circuit 71 connected between the pulse width modulation device 70 and the field emission unit 2, a current feedback circuit 72 connected between the pulse width modulation device 70 and the field emission unit 2, an amplifying circuit 73 connected between the pulse width modulation device 70 and the field emission unit 2, and a protection circuit 74 connected with the pulse width modulation device 70. The voltage feedback circuit 71 is used for feeding back a voltage signal. The current feedback circuit 72 is used for feeding back a current signal. The pulse width modulation device 70 detects the voltage signal and the current signal to adjust the level of the AC power. The protection circuit 74 protects the feedback circuit so as to prevent the circuit from being burned.

The front stage of the amplifying circuit 73 is connected with the pulse width modulation device 70 to form the current feedback circuit 72 for feeding back the AC current and being a stable close loop. After the AC current is fed back to the pulse width modulation device 70, the pulse width modulation device 70 detects the signal level of the feedback AC current. When the level of the feedback signal is distorted, the current density of the field emission unit 2 is affected. At this moment, the pulse width modulation device 70 compensates for the level of the feedback signal to uniform the current density of the field emission unit 2. Therefore, the uniform brightness of the information image displayed on the field emission unit 2 is assured.

The back stage of the amplifying circuit 73 is connected with the pulse width modulation device 70 to form the voltage feedback circuit 71 for feeding back the AC voltage and being a stable close loop. The pulse width modulation device 70 compensates for the feedback AC voltage so that the brightness of the information image displayed on the field emission unit 2 is adequate, and the brightness of the information image is uniform.

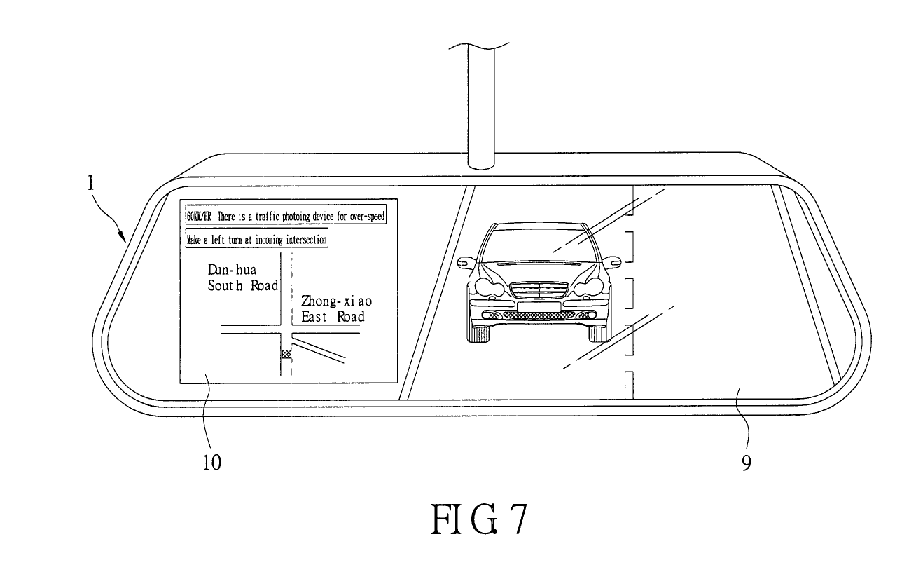

Reference is made to FIG. 7, which shows a perspective view of the display function of the mirror having a field emission information display of the present invention. The driver can see both himself/herself and the traffic status via the mirror surface 9 of the semitransmitting reflecting mirror body 1. The driver also can obtain traffic information (such as the car's position, information regarding traffic, or set a target destination, etc.) via the information image area 10 of the semitransmitting reflecting mirror body 1.

The mirror having a field emission information display of the present invention integrates the field emission unit 2, the semitransmitting reflecting mirror body 1 and the satellite navigation module 4, and is controlled by the control unit 3. The mirror having a field emission information display of the present invention has the following characteristics:

1. The mirror having a field emission information display provides the functions of a mirror and displays information.

2. The brightness of the displayed information is larger than 300 cd/m².

3. The information image is detailed and colorful.

4. The mirror having a field emission information display provides the speed of the car, and can be used as a night lamp.

5. The mirror having a field emission information display cooperates with the satellite navigation module 4 to represent basic information images, such as the optimal route, notification of action that should be taken, etc, by different colors.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A mirror having a field emission information display, comprising:
a semitransmitting reflecting mirror body for a rear vision mirror installed in a car;
a field emission unit installed in the semitransmitting reflecting mirror body, wherein the field emission unit comprises an anode structure, a cathode structure corresponding to the anode structure, and an insulating structure located between the anode structure and the cathode structure to form a specified gap, wherein the anode structure comprises an anode conducting layer, and an anode layer located above the anode conducting layer, and the cathode structure has a cathode conducting layer, and a cathode layer located above the cathode conducting layer;
a control unit installed in the semitransmitting reflecting mirror body, wherein the control unit is connected with the field emission unit for controlling the field emission unit to display the information; and
a satellite navigation module installed in the semitransmitting reflecting mirror body and connected with the control unit, wherein the satellite navigation module receives a satellite signal and transmits the satellite signal to the control unit;
thereby, the satellite signal is controlled by the control unit so as to be transmitted to the field emission unit, and the field emission unit generates an information image area on a surface of the semitransmitting reflecting mirror body.

2. The mirror having a field emission information display as claimed in claim 1, wherein the anode is a fluorescence layer, and the cathode is an emission layer.

3. The mirror having a field emission information display as claimed in claim 1, wherein the cathode is a carbon nanotube layer formed by coating or screen printing by electrophoresis.

4. The mirror having a field emission information display as claimed in claim 2, wherein the emission layer is a carbon nanotube layer or a metal tiny pointed layer.

5. The mirror having a field emission information display as claimed in claim 2, wherein the fluorescence layer is made of a white fluorescence powder.

6. The mirror having a field emission information display as claimed in claim 1, wherein the anode layer is patterned and is composed of fluorescence powder having three original colors, including red, green, and blue, and the thickness of the fluorescence powder layer is within a specified range.

7. The mirror having a field emission information display as claimed in claim 1, wherein the thickness of the anode layer is within a specified range, and the thickness of the anode layer is 2˜10 cm, the thickness of the cathode layer is within a specified range and the thickness of the cathode layer is 1˜20 μm, the thickness of the insulating layer is within a specified range, and the thickness of the insulating layer is 40˜100 μm.

8. The mirror having a field emission information display as claimed in claim 1, wherein the anode structure is connected with an AC power to provide the power required for the field emission unit.

9. The mirror having a field emission information display as claimed in claim 8, wherein the AC power is a high frequency and high voltage AC power.

10. The mirror having a field emission information display as claimed in claim 1, wherein the anode structure further combines with a reflecting layer, and the reflecting layer is located at one side of the anode structure that is opposite to the anode conducting layer.

11. The mirror having a field emission information display as claimed in claim 10, wherein the reflecting layer is implemented by combining a metal material with the anode structure via an evaporation method.

12. The mirror having a field emission information display as claimed in claim 11, wherein the metal material is aluminum.

13. The mirror having a field emission information display as claimed in claim 10, wherein the reflecting layer is combined with the anode structure via a pasting-film method.

14. The mirror having a field emission information display as claimed in claim 1, wherein the control unit comprises a driving circuit module.

15. The mirror having a field emission information display as claimed in claim 1, wherein the control unit comprises a power circuit module.

16. The mirror having a field emission information display as claimed in claim 1, wherein the control unit comprises a feedback circuit module.
